(19) United States
(12) Patent Application Publication
(10) Pub. No.: US 2016/0295620 A1
(43) Pub. Date: Oct. 6, 2016

(54) Device-to-Device Communication in a Cellular Communication System

(71) Applicant: TELEFONAKTIEBOLAGET L M ERICSSON (PUBL), Stockholm (SE)

(72) Inventors: Bengt Lindoff, Bjärred (SE); Stefano Sorrentino, Solna (SE)

(73) Assignee: Telefonaktiebolaget L M Ericsson (PUBL), Stockholm (SE)

(21) Appl. No.: 14/437,038

(22) PCT Filed: Mar. 12, 2015
(86) PCT No.: PCT/EP2015/055187

§ 371 Date: Apr. 20, 2015

Related U.S. Application Data
(60) Provisional application No. 61/951,746, filed on Mar. 12, 2014.
(60) Provisional application No. 62/001,834, filed on May 22, 2014.

(51) Int. Cl. H04W 76/02; H04W 72/04; H04W 72/12

(52) U.S. Cl. CPC H04W 76/023; H04W 72/12; H04W 72/042

(57) ABSTRACT

A method, performed in a controlling node of a cellular communication network is disclosed. The method comprises configuring (1300) gaps during which a device-to-device (D2D) enabled device is not expected to receive any cellular signal, but can use a receiver chain to detect D2D signals or D2D related control information. A corresponding method for the D2D-enabled device is also disclosed.

### TECHNICAL FIELD

The present invention generally relates to device-to-device communication in a cellular communication system.

### BACKGROUND

The term device-to-device (D2D) used in the following corresponds to any direct transmission occurring between two or more cellular devices, i.e. not via one or more network nodes or other network elements, such as an eNodeB, a backbone network, etc., for the purpose of e.g. direct control signalling, direct data communication or peer device presence discovery.

Although the idea of enabling D2D communications as a means of relaying in cellular networks was proposed by some early works on ad hoc networks, the concept of allowing local D2D communications to (re)use cellular spectrum resources simultaneously with ongoing cellular traffic is relatively new. Because the non-orthogonal resource sharing between the cellular and the D2D layers has the potential of reuse gain and proximity gain, at the same time increasing the resource utilization, D2D communications underlying cellular networks has received considerable interest in the recent years.

Specifically, in 3^{rd} Generation Partnership Project Long Term Evolution (3GPP LTE) networks, such as LTE Direct, i.e. employing D2D, communication can be used in commercial applications, such as cellular network offloading, proximity based social networking, or in public safety situations in which first responders need to communicate with each other and with people in the disaster area. See for example the specification 3GPP TR 22.803, V1.0.0, 2012-08.

### SUMMARY

According to a first aspect, there is provided a method performed in a controlling node of a cellular communication network. The method comprises configuring gaps during which a device-to-device (D2D) enabled device is not expected to receive any cellular signal, but can use a receiver chain to detect D2D signals or D2D related control information. Additionally, the gaps may be such that the D2D-enabled device is not expected to transmit any cellular signals during the gaps.

The method may comprise transmitting configuration of gaps to D2D enabled devices of the communication network, signalling a set of gaps for D2D operation. Alternatively, a D2D enabled device may be able to deduce the timing of the gaps from timing of D2D subframes configured to carry D2D channels, whereby explicit signalling of the position of the gaps can be avoided.

A gap may correspond to a subframe configured to carry D2D channels. Alternatively, a gap may be extended before and/or after a subframe configured to carry D2D channels. For example, the gap may be extended by a subframe before and/or after the subframe configured to carry D2D channels.

The method may comprise indicating, to a D2D enabled device, a carrier to be monitored during a gap.

The method may comprise configuring the gaps in such a way that collision with resources potentially used by devices in radio resource control idle, RRC_IDLE, mode in the cell of the controlling node is avoided.

According to a second aspect, there is provided a method performed in a D2D enabled device for operating in a cellular communication system. The method comprises obtaining configuration of gaps, during which the D2D enabled device is not expected to receive any cellular signal, but can use a receiver chain to detect D2D signals or D2D related control information. Additionally, the gaps may be such that the D2D-enabled device is not expected to transmit any cellular signals during the gaps. The configuration may be obtained either by receiving the configuration of gaps from a controlling node of the cellular communication network, or by deducing the timing of the gaps from timing of D2D subframes configured to carry D2D channels, whereby explicit signalling from the controlling node of the position of the gaps can be avoided. Furthermore, the method comprises detecting, during such gaps, D2D signals or D2D-related control information.

A gap may correspond to a subframe configured to carry D2D channels. Alternatively, a gap may be extended before and/or after a subframe configured to carry D2D channels. For example, the gap may be extended by a subframe before and/or after the subframe configured to carry D2D channels.

The method may comprise receiving an indication of a carrier to be monitored during a gap.

The gaps may have been configured in such a way that collision with resources potentially used by devices in RRC_IDLE mode in the cell of the controlling node is avoided.

According to a third aspect, there is provided a controlling node for a cellular communication network. The controlling node comprises a processing element arranged to configure gaps during which a device-to-device, D2D, enabled device is not expected to receive any cellular signal, but can use a receiver chain to detect D2D signals or D2D related control information. Additionally, the gaps may be such that the D2D-enabled device is not expected to transmit any cellular signals during the gaps.

The processing element may be arranged to transmit configuration of gaps to D2D enabled devices of the communication network, signalling a set of gaps for D2D operation. Alternatively, a D2D enabled device may be able to deduce the timing of the gaps from timing of D2D subframes configured to carry D2D channels, whereby explicit signalling of the position of the gaps can be avoided.

A gap may correspond to a subframe configured to carry D2D channels. Alternatively, a gap may be extended before and/or after a subframe configured to carry D2D channels. For example, the gap may be extended by a subframe before and/or after the subframe configured to carry D2D channels.

The processing element may be arranged to indicate, to a D2D enabled device, a carrier to be monitored during a gap.

The processing element may be arranged to configure the gaps in such a way that collision with resources potentially used by devices in RRC_IDLE mode in the cell of the controlling node is avoided.

According to a fourth aspect, there is provided a D2D enabled device for operating in a cellular communication system. The device comprises a processing element arranged to obtain configuration of gaps during which the D2D enabled device is not expected to receive any cellular signal, but can use a receiver chain to detect D2D signals or D2D related control information. Additionally, the gaps may be such that the D2D-enabled device is not expected to transmit any cellular signals during the gaps. The processing element may be arranged to obtain the configuration of gaps either by receiving the configuration of gaps from a controlling node of the cellular communication network, or by deducing the timing of the gaps from timing of D2D subframes configured to carry D2D channels, whereby explicit signalling from the controlling node of the position of the gaps can be avoided. The processing element is further arranged to detect, during such gaps, D2D signals or D2D-related control information.

A gap may correspond to a subframe configured to carry D2D channels. Alternatively, a gap may be extended before and/or after a subframe configured to carry D2D channels. For example, the gap may be extended by a subframe before and/or after the subframe configured to carry D2D channels.

The processing element may be arranged to receive an indication of a carrier to be monitored during a gap.

The gaps may have been configured in such a way that collision with resources potentially used by devices in RRC_IDLE mode in the cell of the controlling node is avoided.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings.

FIG. 1 schematically illustrates the principles for D2D communication within LTE.

FIG. 2 schematically illustrates a time-frequency diagram of a legacy D2D and cellular operation for a FDD carrier pair.

FIG. 3 schematically illustrates an example where devices are using the same operator.

FIG. 4 schematically illustrates a time-frequency diagram of an example where the receiving device may switch the single receiver chain between DL reception and D2D reception in D2D subframes.

FIG. 5 schematically illustrates an example where devices are using randomization of D2D resources.

FIG. 6 schematically illustrates a time-frequency diagram of examples with application of timing offset of the D2D resources.

FIGS. 7 to 11 are a time-frequency diagram schematically illustrating different examples of assignment of timing and/or subcarrier selection for the discovery signal.

FIG. 12 is a block diagram schematically illustrating a network node according to an embodiment.

FIG. 13 is a flow chart illustrating a method according to embodiments, which is performed in a controlling node of the network.

FIG. 14 is a flow chart illustrating a method according to embodiments, which is performed in a controlling node of the network.

FIG. 15 is a flow chart illustrating a method according to embodiments, which is performed in a UE.

FIG. 16 schematically illustrates a computer-readable medium and a processing device.

### DETAILED DESCRIPTION

The context of this disclosure is cellular public land mobile networks (PLMNs). D2D communication entities using an LTE Direct link may reuse the same physical resource blocks (PRB), i.e. time/frequency resources, as used for cellular communications either in the downlink or in the uplink or both. The reuse of radio resources in a controlled fashion can lead to the increase of spectral efficiency at the expense of some increase of the intra-cell interference. Typically, D2D communicating entities use uplink (UL) resources such as UL PRBs or UL time slots, but conceptually it is possible that D2D, such as LTE Direct, communications takes place in the cellular downlink (DL) spectrum or in DL time slots. For ease of presentation, in the present disclosure we assume that D2D links use uplink resources, such as uplink PRBs in an frequency duplex division (FDD) or uplink time slots in an a cellular time division duplex (TDD) system, but the main ideas would carry over to cases in which D2D communications take place in DL spectrum as well.

Various aspects of D2D resource handling are proposed herein. For example, some embodiments introduce the concept of “D2D measurement gaps”. Other embodiments introduce the concept of randomization of D2D resources, or assigning D2D resources according to a dynamic rule. It should be noted that such embodiments could be combined, but could also be employed independently from each other.

In the following, the terms “device” and “UE” (User Equipment) are used interchangeably, and may consider any element that is capable of operating in a cellular communication network, such as a mobile phone, communication card, modem, etc.

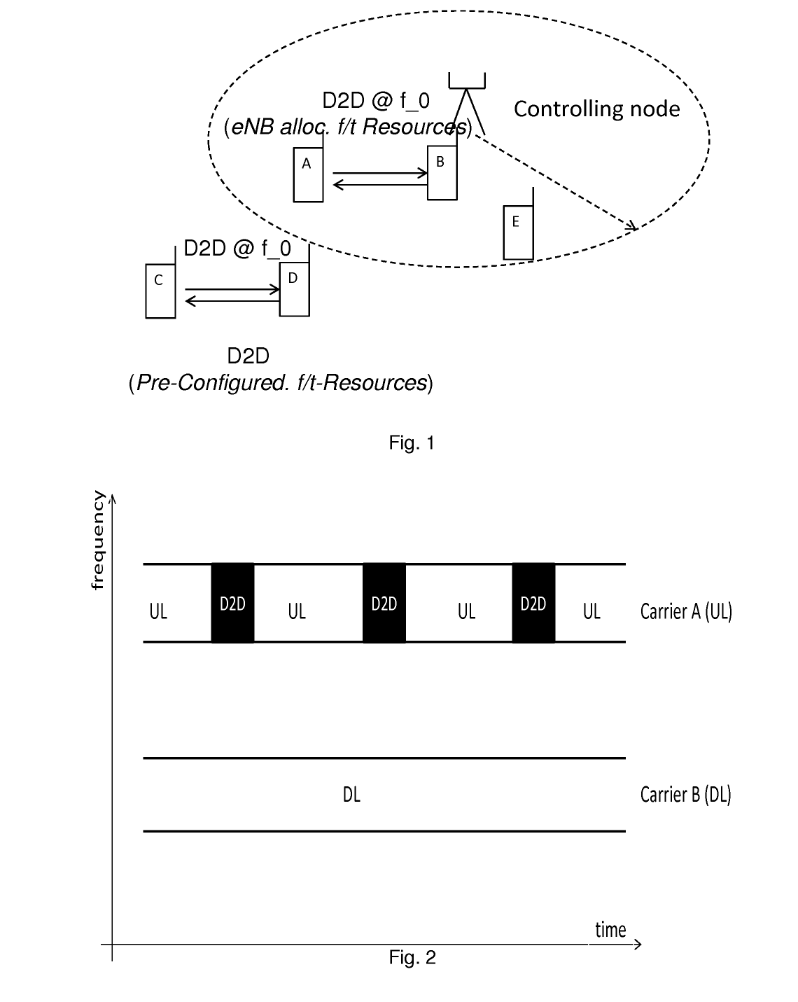

FIG. 1 schematically illustrates the principles for D2D communication within LTE. A controlling node, such as an eNodeB or Cluster Head, is controlling the communication on a frequency carrier f₀. In a first scenario, devices A and B are communicating directly via a D2D link, and both devices are inside NW coverage of the controlling node. The controlling node then allocates the radio resources to use for D2D communication. In the second scenario devices C and D may have D2D communication out of reach from a controlling node, i.e. out of coverage. In this case the D2D communication devices are using pre-configured frequency and/or time resources for D2D communication, which may be assigned by standard or by device capabilities.

FIG. 2 schematically illustrates a legacy D2D and cellular operation for a FDD carrier pair. Two independent receiver chains would thus be needed for the DL and UL carriers in the receiving device.

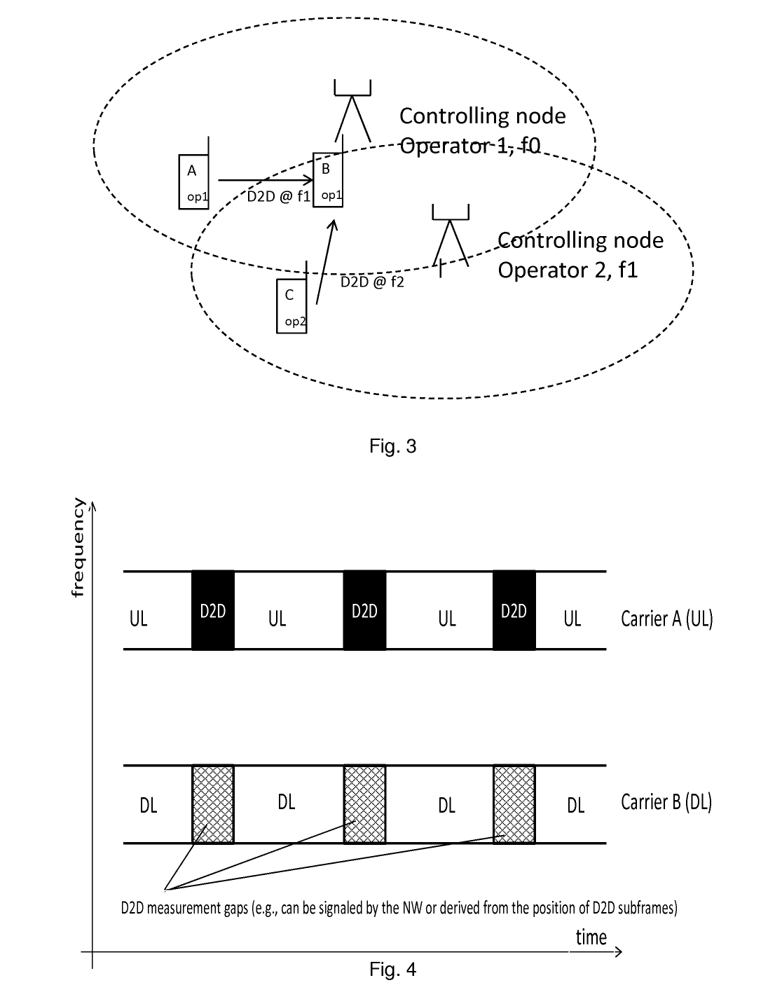

D2D communication within LTE should be able to work for inter-PLMN cases, i.e. with devices operating in another PLMN, e.g. operated by another operator, as well as intra-PLMN but inter-carrier, i.e. with devices operating in the same PLMN but on another carrier in possession of the operator of the PLMN. This means that a device operating under a first operator subscription on a first carrier frequency should be able to discover, and consequently in a later stage also communicate with, a second device operating under a second operator subscription on a second carrier frequency. FIG. 3 schematically illustrates an example where device B may easily detect the device A since they are using the same operator 1. However, device B should also discover device C operating on another carrier frequency under operator 2.

From a regulatory point of view, a device with a subscription for a first operator, i.e. operating in a first PLMN, may not be allowed to transmit in another operator's spectrum, which causes an issue for the inter-PLMN case. Therefore, with the current assumption within 3GPP about inter-PLMN D2D discovery, the device may only transmit D2D signals in own UL spectrum but may be able to monitor and discover D2D signals listen in the spectrum of other PLMNs, which provides a solution for the inter-PLMN case.

Transmitting discovery signals for enabling D2D communication establishment needs to be performed in a cellular communication system to enable one or more D2D enabled device recognising that there is another D2D enabled device which it may perform D2D communication with. Thus, D2D enabled devices monitors discovery signals from other D2D enabled devices, which is performed similar to other search operations within a cellular communication network, e.g. cell search, which is therefore not further elucidated here.

A certain network (NW) node on a certain carrier may for example allocate a subset of resources for D2D discovery or D2D communication. Typically the D2D resources may be allocated on a periodic basis, the periodicity typically standardized, e.g. for instance 29 adjacent subframes every 10th second. Since NW nodes and operators are not synchronized or coordinated, inter-PLMN, and sometimes also intra-PLMN but intra carrier inter NW nodes, or inter-carrier NW nodes, there will be a significant risk for collision between allocated D2D resources between different carrier and inter-PLMN. Furthermore, it may in some embodiments also be true for intra-PLMN, inter carrier or even intra-PLMN, intra-carrier between NW nodes. Then devices from one operator (or camping on one carrier, or one NW node) may not find discovery signals from devices from another operator (or camping on other carriers, or other nodes) due to that the D2D resources may collide. “Collide” may in this context include at least two scenarios: Two devices in the same vicinity transmits discovery signals at the same time and frequency, or a device transmits its discovery signal at a certain time and frequency and another device transmits its discovery signal at a certain time but on another frequency, but may encounter problems spotting the (weak) discovery signal from the first device e.g. due to self-introduced interference degrading receiving performance at the transmitting of the own discovery signal. A further scenario may be that a UE need to listen for discovery signals on own operator carrier at a time instant but another carrier also have allocated D2D resources at that time instant. Hence the device may not be able to listen on several carriers at the same time.

Some of the embodiments assume that a NW node, e.g., eNodeB, is aware of the D2D resources potentially used by at least some neighbour UEs. Such resources may consist of the D2D resources used in a neighbour cell, on another carrier, by another PLMN, by out of coverage UEs, which are possibly coordinated by a third device, etc. The term “resources” indicates time and/or frequency resources on a given carrier. The NW node may acquire information regarding the D2D resources used by devices in proximity in any way, including signalling and measurements.

The embodiments may be combined in any way.

According to some embodiments, there are provided D2D measurement gaps, signalling by the NW and corresponding UE behaviour.

According to some embodiments, a rule is defined such that a UE is exempted from cellular DL reception and/or UL transmission whenever the condition(s) defined in the rule are fulfilled. Some examples of rules are
On a given carrier, a UE is exempted from the requirement to read DL channels in subframes that potentially carry D2D channels, or D2D signals.
On a given carrier, a UE is exempted from the requirement to transmit UL channels in subframes that potentially carry D2D channels, or D2D signals, on a given carrier.

The different rules may be combined.

The set of subframes potentially carrying D2D channels, or D2D signals, may be signalled to the UE by the NW or may be obtained by the UE by measurements. The rules given as examples above may be defined in specifications or signalled by the NW to the UEs.

An advantage of some embodiments is that it enables a UE to reuse a common transceiver for both D2D and cellular communications, on a certain carrier or on multiple carriers. In other words, the behaviour proposed above allows a UE to use the transceiver chain to read and/or transmit D2D signals in D2D subframes, i.e., subframes potentially used for D2D. The term “D2D measurement gap” is thus not intended to limit the use of such gaps strictly to D2D signal measurements, but they can also be used for actual transmission and reading of D2D signals. Alternative labels for such gaps may e.g. be “D2D gaps” or simply “gaps”, or “interruptions”, during which a D2D enabled device is not expected to transmit and/or receive any cellular signal, but can use a receiver chain to detect D2D signals or D2D related control information and/or use a transceiver chain to read and/or transmit D2D signals in D2D subframes. It is noted that the above example rules may be limited to certain types of D2D subframes, such as subframes potentially carrying discovery messages, subframes potentially carrying D2D scheduling assignments, subframes potentially carrying D2D data, subframes potentially carrying D2D control information, etc.

According to some embodiments, additional examples of rules for exempting UEs from the requirement to transmit and/or receive cellular signals in favour of D2D transmission and/or reception. All the rules discussed here may be combined in any way.

The NW may configure and signal a set of measurement gaps for D2D operation. Such measurement gaps may be limited to UL and/or DL resources, only. The term measurement gap means that the UEs are not expected to transmit and/or receive any cellular signal on the serving cell during the measurement gap. The advantage of the measurement gap, from a UE perspective, is that the UE can free up hardware resources, e.g. the receiver chain, to perform D2D operation on a neighbour cell or another carrier. A further potential advantage of D2D measurement gaps is that co-channel interference may be lower during D2D measurement gaps.

Possibly, the NW may indicate to the UE which carrier should be preferably monitored during the D2D measurement gaps.

The D2D measurement gaps may overlap with the D2D subframes as defined above. In this case, explicit signalling of the position of the D2D measurement gaps may be avoided by the NW, because the UE is able to deduce the timing of the D2D measurement gaps from the timing of the D2D subframes.

Some examples of rules defining the UE behaviour with D2D measurement gaps may be
On a given carrier, a UE is exempted from the requirement to read DL channels in subframes that are D2D measurement gaps.
On a given carrier, a UE is exempted from the requirement to transmit UL channels in subframes that are D2D measurement gaps.

Also here, different rules may be combined in any way.

As an example, consider a FDD D2D-enabled UE equipped with a single receiver chain. Normally, the receiver chain operates on DL spectrum, i.e. for cellular DL, or UL spectrum, i.e. for D2D reception, on the serving cell. During D2D measurement gaps, the receiver chain may be used to detect D2D signals or D2D related control information, which may be transmitted by UEs, by eNodeBs or by other nodes, either on the serving cell carrier or on other carriers. This is schematically illustrated in FIG. 4, wherein the receiving device may switch the single receiver chain between DL reception and D2D reception in D2D subframes.

According to some embodiments, there are provided configuration of the D2D measurement gaps by the NW and exceptions to D2D measurement gaps.

In some embodiments, the NW configures D2D measurement for a given UE on at least a subset of the resources assigned to D2D transmissions on the own cell and/or on other cells. Such other cells may operate on the same or on other carriers as the NW node configuring the D2D measurement gaps. The NW node may acquire information regarding the D2D resources used by devices in proximity in various ways, including signalling over backhaul, signalling by UEs and over the air measurements.

The NW may even configure the D2D measurement gaps in such a way that collision with resources potentially used by RRC_IDLE UEs in the cell is avoided. For example, the D2D measurement gaps may be arranged not to overlap with subframes used for paging, random access channel (RACH), synchronisation signal (e.g. primary/secondary synchronisation signals, PSS/SSS) transmission, broadcast control information, cellular measurement gaps, etc.

In order to handle potential collisions between D2D measurement gaps and subframes used by at least RRC_IDLE UEs for important cellular operations, there may be defined modified rules for handling the D2D measurement gaps defined as demonstrated above. Examples of modified rules may be
On a given carrier, a UE is exempted from the requirement to read DL channels in subframes that are D2D measurement gaps and that do not potentially carry paging, RACH, synchronisation signals, broadcast control information or that are cellular measurement gaps.
On a given carrier, a UE is exempted from the requirement to transmit UL channels in subframes that are D2D measurement gaps and that do not potentially carry paging, RACH, synchronisation signals, broadcast control information or that are cellular measurement gaps.

It is to be understood that the above rules are mere examples. In particular, not all the channels mentioned in the above example rules need to be included in the agreed rules. Also, D2D measurement gaps may or may not have higher priority than legacy cellular measurement gaps in defining the UE behaviour.

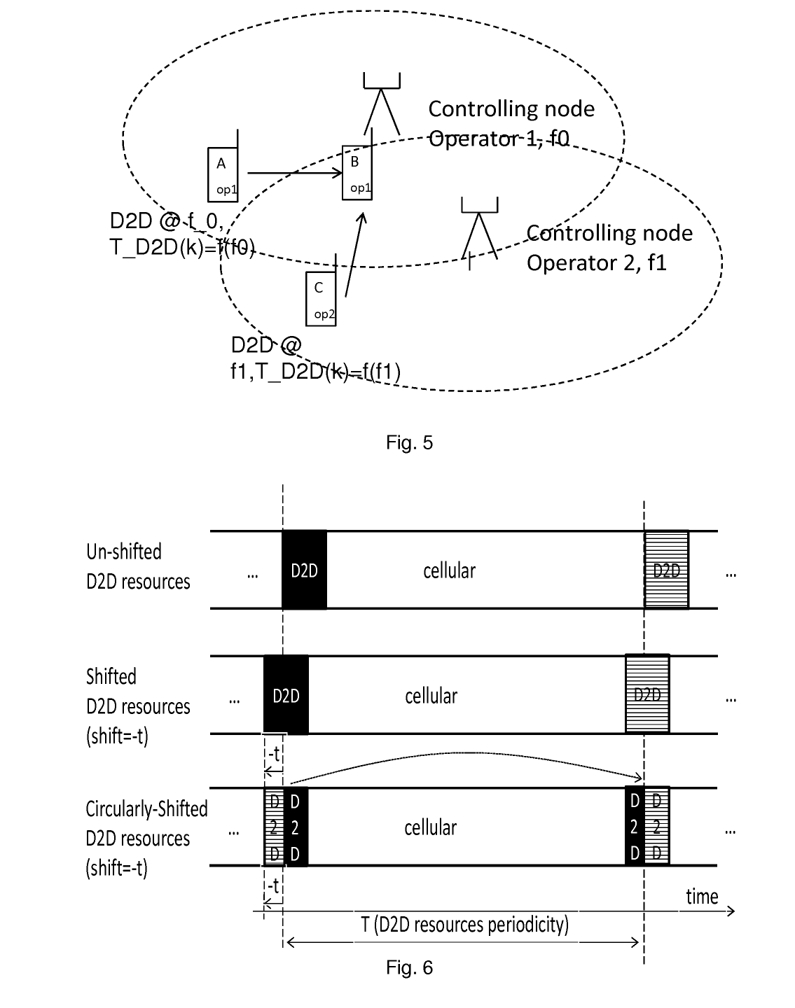

According to some embodiments, there are provided randomisation of D2D resources. Reference is here made to FIG. 5 for the context of the network elements. Randomization should in this context be considered to arrange or choose something in a random way or order, to make something random. Random should however be considered in sense how the randomization appears for an observer, although the arranging of the “random” pattern by the creator, i.e. the particular UE that transmits the discovery signal, follows a deterministic rule, e.g. based on a pseudo-random and/or other function.

In some embodiments, the D2D resources used by a certain cell, carrier, PLMN or similar are randomized in a way that reduces the probability of systematic time overlap, i.e. collision, with the D2D resources used in another cell or/and carrier or/and PLMN.

Possibly, the randomization may be constructed or constrained in such a way that D2D resources on a given carrier never overlap with the paging subframes and/or random access resources and/or broadcast control information resources on a given carrier. This is to allow the UE to switch the transceiver between cellular and D2D reception and avoid collisions between cellular and D2D for a given carrier. Possibly, the D2D resources may be indicated by a non-zero time offset relative to the paging resources on a given carrier.

In one example, D2D resources have a periodic structure with a pre-defined or configurable period T (with the origin relative to a subframe numbering or other counter relevant for the carrier). The D2D resources are time-shifted by a timing offset, e.g., [0, . . . , T−1] or [−T/2+1, . . . , T/2]), which may be cell, carrier or PLMN specific. Possibly, when a shift is applied, the D2D resources are circularly shifted within the period T, as is illustrated in FIG. 6.

In some examples, there exist some rules for implicit derivation of the D2D resources shift. For example, the shift may be a function of one or more parameters such as, e.g., the PLMN Identity, the Physical Cell Identity, the Virtual Cell Identity, the Carrier Frequency, the LTE channel number EARFCN, etc. In some examples the shift may also be related to a common clock valid for all carriers, for instance a clock based on GPS. A common clock or time reference for the time shifts may help to avoid that the time shifts collide anyway due to different time references for different PLMNs.

In some examples, the D2D resource allocation and/or the D2D resource shift are time-varying, possibly according to a pre-defined pattern. For example, the time shift may be periodically updated based on a predefined pattern of shifts. The time-shift pattern may be a function of, or may be initialized as a function of, e.g., the PLMN Identity, the Physical Cell Identity, the Virtual Cell Identity, the Carrier Frequency, EARFCN, etc. This ensures that systematic resource collisions are avoided between cells and/or carriers.

This can be alleviated by assigning, for each of the D2D enabled devices, either of a time in a periodic time schedule and at least a subcarrier among a plurality of subcarriers assigned for carrier for D2D communication of the communication system based on a dynamic rule for spreading timing and/or subcarrier selection for the discovery signal. The risk of collision may thus be reduced. The discovery signal is thus transmitted by the respective D2D enabled device according to the time and subcarrier assignment. Since a dynamic rule is applied, the probability of collision is reduced. For the example mentioned above, the timing may be assigned in any of the 29 adjacent subframes, wherein the devices may assign that differently to reduce the collision risk.

For example, consider that D2D resources have a periodic structure with a pre-defined period T, but an offset (0,. . . , T) may be cell, carrier or PLMN dependent. Note that the D2D resources may correspond to a resource pattern in time and/or frequency domains. A pattern may correspond to a certain subset of subframes and the pattern may be periodic every T subframes. In one example the dependence on carrier frequency may be based on the carrier frequency, e.g., E-UTRA Absolute Radio Frequency Channel Number (EARFCN), i.e. the LTE channel number. Hence, the D2D resources may be allocated according to

T_{D2D}(k)=k*T+t₀(EARFCN), 0<t₀<T, k=1, 2, 3 . . .

where T_{D2D} is the D2D resource allocation in time, e.g. sub frame number, and t₀(.) is the offset during the period T. In some embodiments the sub frame numbers may be aligned over carriers based on a common clock, e.g. GPS time reference.

Additionally or alternatively, a carrier or PLMN dependent jitter is added to the period T of the D2D resources, wherein the period may be fixed, or provided as demonstrated above. Again the jitter may be based on the EARFCN. Hence, the D2D resources may be allocated according to

T_{D2D}(k)=k*T+t₁(EARFCN,k) −x<t₁<x

where the timing t₁ is jittering around 0 as function of the EARFCN and sub frame number. In some embodiments the sub frame numbers may be aligned over carriers based on a common clock, e.g. GPS time reference.

As an extension to the above PLMN or carrier frequency dependent randomization, the timing or jitter may also be randomised based on physical cell identity or Cluster Head/sync source identity.

In yet another example the offset may be carrier/PLMN dependent, while the jitter may depend on physical cell ID (PCI), or vice versa, and hence the D2D allocation for a certain node on a certain carrier/PLMN may include both an offset and a jitter.

Additionally or alternatively, the randomization may be done in frequency domain, i.e. which Resource Blocks (RBs) that are allocated to D2D resources for a given cell/Cluster head identity, carrier frequency or PLMN etc. similar to the functions demonstrated above for the timing offset. Such a randomization approach may be especially suitable for the intra-carrier case, and hence as a function of the transmitting node identity, e.g. Physical Cell ID or Global Cell ID. Such randomization may reduce the risk for collision between D2D resources between cells and hence may reduce the interference risk and increase the detection probability.

Further, randomization may further be provided over a longer time scale. In one example, a variation on a larger scale, i.e. larger than the D2D resource periodicity T as demonstrated above, may be provided. For example every of the longer periods, i.e. in the order of one or a few minutes, the assignment is changed. The change may be as a function of carrier, PLMN, cell ID etc., and may for example be a variation of the function demonstrated above.

The randomization may be determined from a shift register with an initial state, i.e. seed, that is a function of carrier frequency, PLMN, cell ID etc. In another example, a general mathematical function may generate the randomization as a function of carrier frequency, PLMN, cell ID etc. In yet another example, the randomization may be determined from a pre-defined look up table, which for example may be given by the specifications of the communication system.

The assignment of time may be arranged to comprise one of a plurality of timing offset steps. The timing offset steps may be in the time-frequency resources as demonstrated above, i.e. the physical resource blocks defined by the communication system. The assignment may also comprise jittering the time around the respective timing offset step. Assignment of “time” should in this context be considered any of a start time, a stop time, or a time associated with a specific instant, e.g. centre time, of a time interval assigned for the transmission of the discovery signal. The assignment of “time” may additionally include assignment of the duration of the time interval.

The dynamic rule may comprise a function of one or more identifiers provided by the communication system such that timing assignment for respective D2D enabled device is determined by the function. An example of this is given above. The identifiers provided by the communication system may for example comprise one or more of a carrier frequency, a network identity, a cell identity, etc., wherein the function may determine the timing therefrom.

The dynamic rule may for example comprise a stochastic randomization function or a pseudo-random function. A seed for the pseudo-random function may for example be one or more of a carrier frequency, a network identity, a cell identity, etc.

The assignment of subcarrier or subcarriers may comprise one of a plurality of subcarrier sets within the physical resource blocks defined by the communication system. Similar to the assignment of timing, the assignment of subcarrier or subcarriers, sole or in combination with the assignment of timing, may be based on a function of one or more identifiers provided by the communication system such that subcarrier assignment for respective D2D enabled device is determined by the function. For example, the identifiers provided by the communication system on which the function determines subcarrier assignment may comprises one or more of a carrier frequency, a network identity, a cell identity, etc. Also for the assignment of subcarrier or subcarriers, a stochastic randomization function or a pseudo-random function may be used. A seed for the pseudo-random function may for example be one or more of a carrier frequency, a network identity, a cell identity, etc.

The dynamic rule may be coordinated from a controlling node, e.g. an eNodeB or Cluster Head, of the communication system. Further examples of this will be given below.

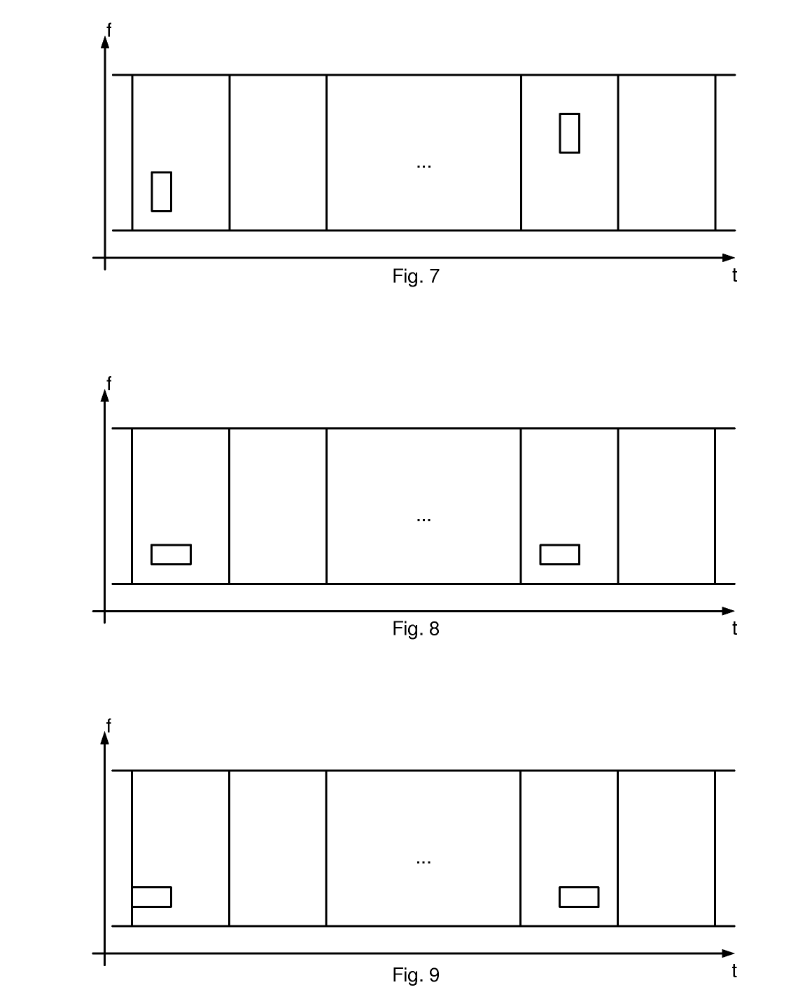

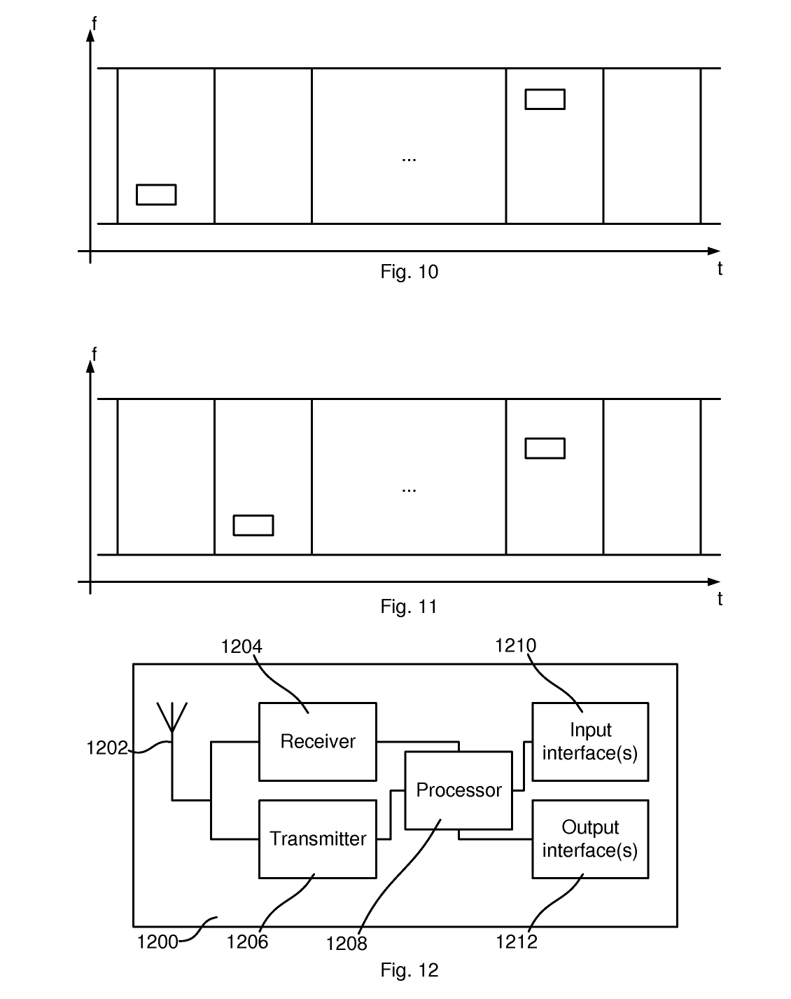

FIGS. 7 to 11 are a time-frequency diagram schematically illustrating different examples of assignment of timing and/or subcarrier selection for the discovery signal. FIG. 7 illustrates an example where assignment of time and subcarrier is made according to dynamic rules, e.g. randomized by pseudo-random schemes. FIG. 8 illustrates an example where assignment of time and subcarrier is made according to a rule where time and subcarrier is assigned to the same resource for each period T. FIG. 9 illustrates an example where assignment of time is made according to a dynamic rule, e.g. randomized by a pseudo-random scheme and subcarrier is assigned to the same resource for each period T. FIG. 10 illustrates an example where assignment of time is assigned to the same resource for each period T and subcarrier is made according to a dynamic rule, e.g. randomized by a pseudo-random scheme. FIG. 11 illustrates an example where assignment of time is assigned to the same resource for each period T, but is circularly shifted, and subcarrier is made according to a dynamic rule, e.g. randomized by a pseudo-random scheme. It is to be understood that the examples are numerous, and only a few of them are illustrated here.

FIG. 12 is a block diagram schematically illustrating a network node 1200, e.g. an UE according to some embodiments. The network node comprises an antenna arrangement 1202, a receiver 1204 connected to the antenna arrangement 1202, a transmitter 1206 connected to the antenna arrangement 1202, a processing element 1208 which may comprise one or more circuits, one or more input interfaces 1210 and one or more output interfaces 1212. The interfaces 1210, 1212 can be user interfaces and/or signal interfaces, e.g. electrical or optical. The network node 1200 is arranged to operate in a cellular communication network. In particular, by the processing element 1208 being arranged to perform the embodiments demonstrated with reference to FIGS. 1 to 11, the network node 1200 when being a UE or Cluster Head is capable of D2D communication as demonstrated above. The network node 1200 may also be a controlling node of the cellular network, e.g. an eNodeB or a Cluster Head, and be arranged to perform the therewith associated tasks as demonstrated above. The processing element 1208 can also fulfill a multitude of tasks, ranging from signal processing to enable reception and transmission since it is connected to the receiver 1204 and transmitter 1206, executing applications, controlling the interfaces 1210, 1212, etc.

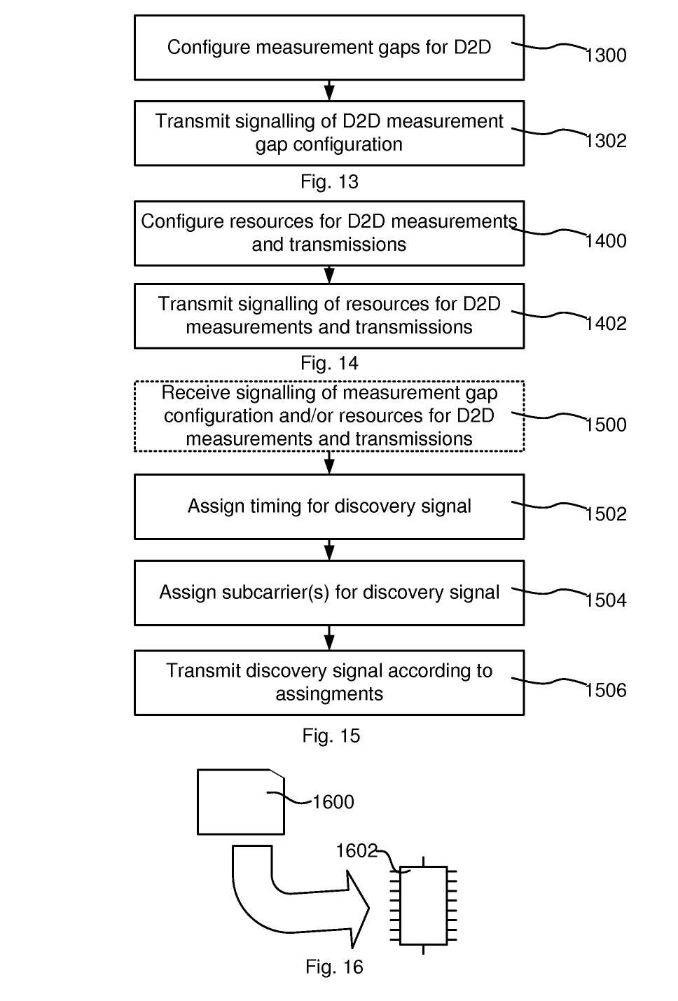

FIG. 13 is a flow chart illustrating a method according to embodiments, which is performed in a controlling node of the NW, e.g. an eNodeB or Cluster Head. D2D measurement gaps are configured 1300. The configuration of measurement gaps are then transmitted 1302 to UEs as signalling of a set of measurement gaps for D2D operation. Such measurement gaps may be limited to UL and/or DL resources, only. The term measurement gap means that the UEs are not expected to transmit and/or receive any cellular signal on the serving cell during the measurement gap, as demonstrated above. Possibly, the signalling may indicate to the UE which carrier should be preferably monitored during the D2D measurement gaps. The D2D measurement gaps may overlap with the D2D subframes as defined above. In this case, explicit signalling of the position of the D2D measurement gaps may be avoided, because the UE is able to deduce the timing of the D2D measurement gaps from the timing of the D2D subframes.

FIG. 14 is a flow chart illustrating a method according to embodiments, which is performed in a controlling node of the NW, e.g. an eNodeB or Cluster Head. The D2D measurement is configured 1400 for a given UE on at least a subset of the resources assigned to D2D transmissions on the own cell and/or on other cells. Such other cells may operate on the same or on other carriers as the NW node configuring the D2D measurement gaps. The NW node may acquire information regarding the D2D resources used by devices in proximity in various ways, including signalling over backhaul, signalling by UEs and over the air measurements. The NW may even configure the D2D measurement gaps in such a way that collision with resources potentially used by RRC_IDLE UEs in the cell is avoided. For example, the D2D measurement gaps may be arranged not to overlap with subframes used for paging, random access channel (RACH), synchronisation signal (e.g. primary/secondary synchronisation signals, PSS/SSS) transmission, broadcast control information, cellular measurement gaps, etc. The configuration of resources are then transmitted 1402 to UEs as signalling of a set of resources for D2D operation.

FIG. 15 is a flow chart illustrating a method according to embodiments, which is performed in a UE. Optionally, if such configurations are provided by the NW, as demonstrated with reference to FIGS. 13 and/or 14 above, the UE receives 1500 signalling of measurement gap configuration and/or resources for D2D measurements and transmissions, and adapts accordingly. Additionally or alternatively, the UE may adapt according to function of one or more identifiers provided by the communication system, as also demonstrated above. These adaptations have impact on assignment 1502 of timing for a discovery signal and/or assignment 1504 of subcarrier or subcarriers for the discovery signal, which are performed 1502, 1504 accordingly. The discovery signal is then sent 1506 according to the assignments.

According to some embodiments, additional examples of rules for exempting UEs from the requirement to transmit and/or receive cellular signals in favour of D2D transmission and/or reception. All the rules discussed here may be combined in any way.

The NW may configure and signal a set of measurement gaps for D2D operation. Such measurement gaps may be limited to UL and/or DL resources, only. The term measurement gap means that the UEs are not expected to transmit and/or receive any cellular signal on the serving cell during the measurement gap. The advantage of the measurement gap, from a UE perspective, is that the UE can free up hardware resources, e.g. the receiver chain, to perform D2D operation on a neighbour cell or another carrier. A further potential advantage of D2D measurement gaps is that co-channel interference may be lower during D2D measurement gaps.

Possibly, the NW may indicate to the UE which carrier should be preferably monitored during the D2D measurement gaps. For example, there may be a need to consider long transition periods when switching between cellular and D2D operation, e.g. one subframe. This may be combatted by for example larger DL gaps 1701-1702 with a nested smaller UL gap 1703-1705, respectively. This is feasible since only DL is affected by switching time. The D2D measurement gaps may overlap with the D2D subframes as defined above. In this case, explicit signalling of the position of the D2D measurement gaps may be avoided by the NW, because the UE is able to deduce the timing of the D2D measurement gaps from the timing of the D2D subframes. The measurement gaps may be

Some examples of rules defining the UE behaviour with D2D measurement gaps may be
On a given carrier, a UE is exempted from the requirement to read DL channels in subframes that are D2D measurement gaps, wherein the gaps are extended, e.g. by a further subframe before and/or after (cf. embodiment demonstrated with reference to FIG. 4).
On a given carrier, a UE is exempted from the requirement to transmit UL channels in subframes that are D2D measurement gaps, wherein the gaps are extended, e.g. by a further subframe before and/or after (cf. embodiment demonstrated with reference to FIG. 4).

Accordingly, the D2D measurement gaps may include a subframe before and/or after a D2D subframe.

Also here, different rules may be combined in any way.

As an example, consider a FDD D2D-enabled UE equipped with a single receiver chain. Normally, the receiver chain operates on DL spectrum, i.e. for cellular DL, or UL spectrum, i.e. for D2D reception, on the serving cell. During D2D measurement gaps, the receiver chain may be used to detect D2D signals or D2D related control information, which may be transmitted by UEs, by eNodeBs or by other nodes, either on the serving cell carrier or on other carriers. This is schematically illustrated in FIG. 17, wherein the receiving device may switch the single receiver chain between DL reception and D2D reception in D2D subframes within the extended gap.

The larger measurement gaps as illustrated in FIG. 17 may for example also be used upon extended D2D communications which occupies several consecutive subframes of the UL carrier. This is schematically illustrated in FIG. 18. This approach may also include that one or more subframes 1900-1905 of the UL carrier may be reserved for D2D communication, wherein the reservation corresponds to the extended measurement gaps as demonstrated with reference to FIG. 17. An approach accordingly is illustrated in FIG. 19.

A further purpose of the extended (compared with the embodiment demonstrated with reference to FIG. 4) gaps is that, depending on needs and situation, the extended gaps may be used for further measurements. An example is illustrated in FIG. 20, where measurement, in addition to the measurement of D2D subframe on carrier B, may be performed on a DL subframe on a carrier C and/or on another D2D subframe on a carrier D.

In line with the similar strive towards versatility, the reserved UL subframes demonstrated with reference to FIG. 19 may be used in a similar way, e.g. for performing measurements such that mobility etc. is enhanced.

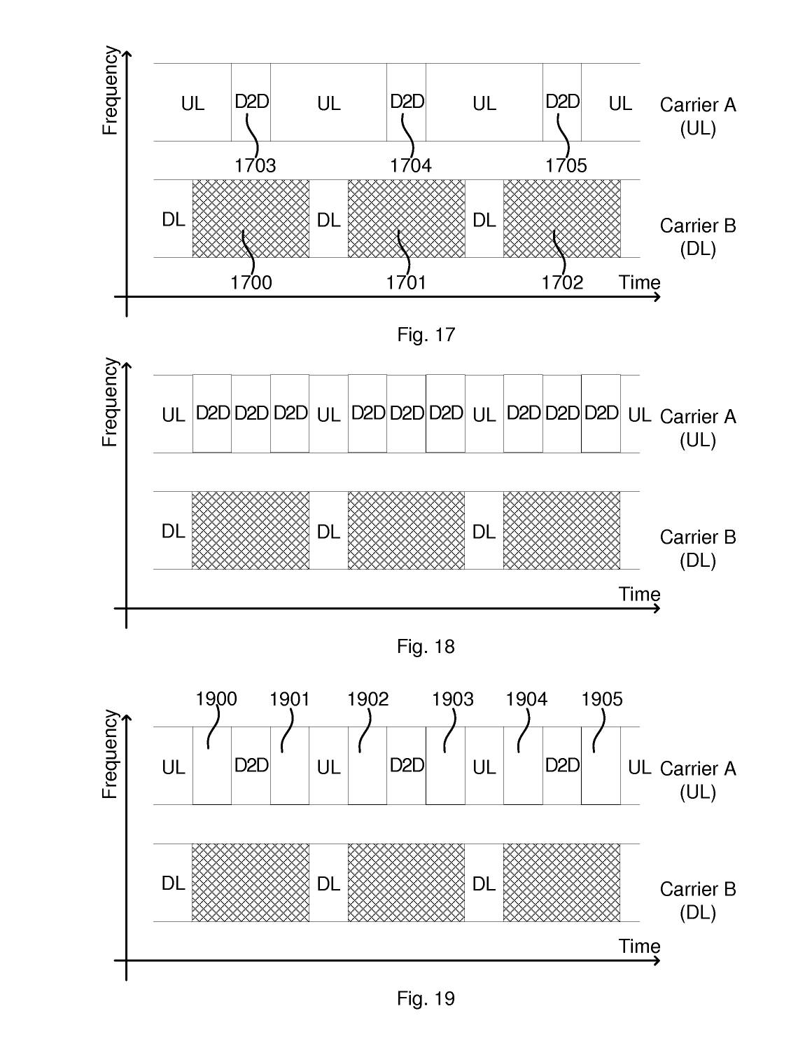

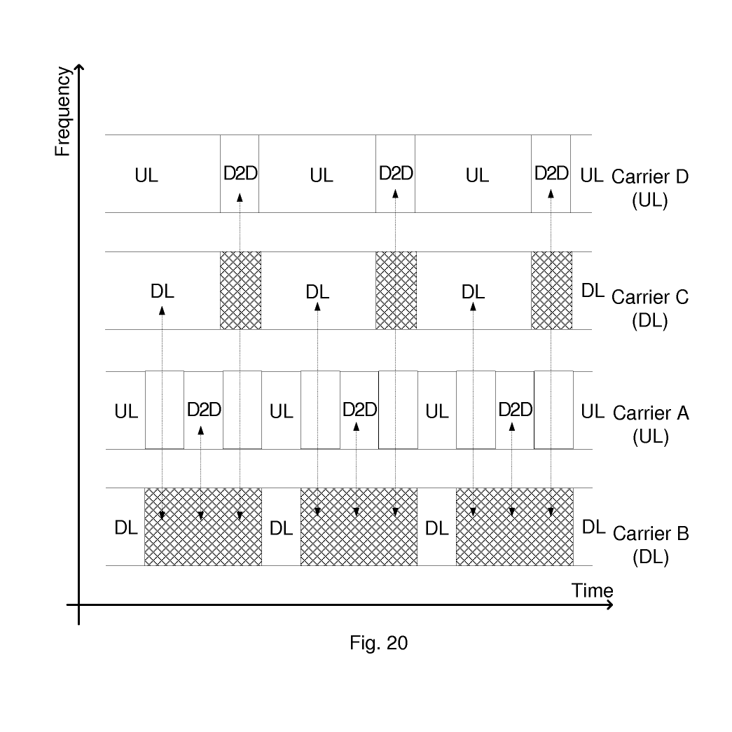

The methods according to the present invention is suitable for implementation with aid of processing means, such as computers and/or processors, especially for the case where the processing element 1208 demonstrated above comprises a processor handling resource assignment. Therefore, there is provided computer programs, comprising instructions arranged to cause the processing means, processor, or computer to perform the steps of any of the methods according to any of the embodiments described with reference to FIGS. 1 to 11, 13 to 15, and 17 to 20. The computer programs preferably comprises program code which is stored on a computer readable medium 1600, as illustrated in FIG. 16, which can be loaded and executed by a processing means, processor, or computer 1602 to cause it to perform the methods, respectively, according to embodiments of the present invention, preferably as any of the embodiments described with reference to FIGS. 1 to 11, 13 to 15, and 17 to 20. The computer 1602 and computer program product 1600 can be arranged to execute the program code sequentially where actions of the any of the methods are performed stepwise. The processing means, processor, or computer 1602 is preferably what normally is referred to as an embedded system. Thus, the depicted computer readable medium 1600 and computer 1602 in FIG. 16 should be construed to be for illustrative purposes only to provide understanding of the principle, and not to be construed as any direct illustration of the elements.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed herein and that modifications and other embodiments are intended to be included within the scope of this disclosure. Although specific terms may be employed herein, they are used in a generic and descriptive sense only and not for purposes of limitation.

1-32. (canceled)

33. A method, performed in a controlling node of a cellular communication network, comprising:
configuring gaps during which a device-to-device (D2D)-enabled device is not expected to receive any cellular signal, but can use a receiver chain to detect D2D signals or D2D-related control information.

34. The method of claim 33, wherein the D2D-enabled device is not expected to transmit any cellular signals during the gaps.

35. The method of claim 33, further comprising transmitting configuration of gaps to D2D-enabled devices of the communication network, thereby signaling a set of gaps for D2D operation.

36. The method of claim 33, wherein a D2D-enabled device is able to deduce the timing of the gaps from timing of D2D subframes configured to carry D2D channels or D2D signals, whereby explicit signaling of the position of the gaps can be avoided.

37. The method of claim 33, wherein a gap corresponds to a subframe configured to carry D2D channels.

38. The method of claim 33, wherein a gap is extended before and/or after a subframe configured to carry D2D channels.

39. The method of claim 38, wherein the gap is extended by a subframe before and/or after the subframe configured to carry D2D channels.

40. The method of claim 33, further comprising indicating, to a D2D-enabled device, a carrier to be monitored during a gap.

41. The method of claim 33, comprising configuring the gaps in such a way that collision with resources potentially used by devices in radio resource control idle (RRC_IDLE) mode in the cell of the controlling node is avoided.

42. A method performed in a D2D-enabled device for operating in a cellular communication system, comprising:
obtaining configuration of gaps during which the D2D-enabled device is not expected to receive any cellular signal but can use a receiver chain to detect D2D signals or D2D-related control information, either by:
receiving the configuration of gaps from a controlling node of the cellular communication network; or
deducing the timing of the gaps from timing of D2D subframes configured to carry D2D channels, whereby explicit signaling from the controlling node of the position of the gaps can be avoided; and
detecting, during gaps, D2D signals or D2D-related control information.

43. The method of claim 42, wherein the D2D-enabled device is not expected to transmit any cellular signals during the gaps.

44. The method of claim 42, wherein a gap corresponds to a subframe configured to carry D2D channels.

45. The method of claim 42, wherein a gap is extended before and/or after a subframe configured to carry D2D channels.

46. The method of claim 45, wherein the gap is extended by a subframe before and/or after the subframe configured to carry D2D channels.

47. The method of claim 42, further comprising receiving an indication of a carrier to be monitored during a gap.

48. The method of claim 42, wherein the gaps have been configured in such a way that collision with resources potentially used by devices in radio resource control idle (RRC_IDLE) mode in the cell of the controlling node is avoided.

49. A controlling node for a cellular communication network, comprising a processing circuit configured to:
configure gaps during which a device-to-device (D2D)-enabled device is not expected to receive any cellular signal but can use a receiver chain to detect D2D signals or D2D-related control information.

50. The controlling node of claim 49, wherein the D2D-enabled device is not expected to transmit any cellular signals during the gaps.

51. The controlling node of claim 49, wherein the processing circuit is further configured to transmit configuration of gaps to D2D-enabled devices of the communication network, thereby signaling a set of gaps for D2D operation.

52. The controlling node of claim 49, wherein a D2D-enabled device is able to deduce the timing of the gaps from timing of D2D subframes configured to carry D2D channels, whereby explicit signaling of the position of the gaps can be avoided.

53. The controlling node of claim 49, wherein a gap corresponds to a subframe configured to carry D2D channels.

54. The controlling node of claim 49, wherein a gap is extended before and/or after a subframe configured to carry D2D channels.

55. The controlling node of claim 54, wherein the gap is extended by a subframe before and/or after the subframe configured to carry D2D channels.

56. The controlling node of claim 49, wherein the processing circuit is further configured to indicate, to a D2D-enabled device, a carrier to be monitored during a gap.

57. The controlling node of claim 49, wherein the processing circuit is configured to configure the gaps in such a way that collision with resources potentially used by devices in radio resource control idle (RRC_IDLE) mode in the cell of the controlling node is avoided.

58. A D2D-enabled device for operating in a cellular communication system, comprising a processing circuit configured to:
obtain configuration of gaps during which the D2D-enabled device is not expected to receive any cellular signal but can use a receiver chain to detect D2D signals or D2D-related control information, either by:
receiving the configuration of gaps from a controlling node of the cellular communication network; or
deducing the timing of the gaps from timing of D2D subframes configured to carry D2D channels, whereby explicit signaling from the controlling node of the position of the gaps can be avoided; and
detect, during gaps, D2D signals or D2D-related control information.

59. The D2D-enabled device of claim 58, wherein the D2D-enabled device is not expected to transmit any cellular signals during the gaps.

60. The D2D-enabled device of claim 58, wherein a gap corresponds to a subframe configured to carry D2D channels.

61. The D2D-enabled device of claim 58, wherein a gap is extended before and/or after a subframe configured to carry D2D channels.

62. The D2D-enabled device of claim 61, wherein the gap is extended by a subframe before and/or after the subframe configured to carry D2D channels.

63. The D2D-enabled device of claim 58, wherein the processing circuit is further configured to receive an indication of a carrier to be monitored during a gap.

64. The D2D-enabled device of claim 58, wherein the gaps have been configured in such a way that collision with resources potentially used by devices in radio resource control idle (RRC_IDLE) mode in the cell of the controlling node is avoided.
